(19) United States
(12) Patent Application Publication
(10) Pub. No.: US 2004/0061357 A1
(43) Pub. Date: Apr. 1, 2004

(54) Rear case assembly for trailer body

(76) Inventors: Russell S. Long, Murrysville, PA (US); Richard A. Uhal, McKeesport, PA (US); Brian J. Malloy, North Aurora, IL (US)

Correspondence Address: ALCOA INC, ALCOA TECHNICAL CENTER, 100 TECHNICAL DRIVE, ALCOA CENTER, PA, 15069-0001, US

(21) Appl. No.: 10/662,112

(22) Filed: Sep. 12, 2003

Related U.S. Application Data
(60) Provisional application No. 60/411,726, filed on Sep. 17, 2002.

(51) Int. Cl. B62D 33/00

(52) U.S. Cl. 296/186.3

(57) ABSTRACT

An aluminum rear case assembly (12) for a trailer body (10) includes a rectangular frame assembly (16). The frame assembly (16) includes an extruded aluminum top rail (22), an extruded aluminum bottom rail (24), and a pair of extruded aluminum side rails (26) connecting the top and bottom rails (22, 24). The top, bottom, and side rails (22, 24, 26) are joined to define the rectangular shape. The frame assembly (16) has an exposed side (18) facing outward from the trailer body (10) and an internal side (20) facing inward toward the cargo area defined by the trailer body (10) and attached to the rear end of the trailer body (10).

### RELATED APPLICATION

This application claims the benefit of U.S. Provisional Patent Application Serial No. 60/411,726, filed Sep. 17, 2002, entitled “Rear Case Assembly For Trailer Bodies”, the disclosure of which is incorporated herein in its entirety.

### BACKGROUND OF THE INVENTION

1. Field of the Invention

The present invention relates generally to a rear case assembly for a trailer body and, more particularly, a rear case assembly for a tractor trailer body that is comprised of light weight structural members.

2. Description of Related Art

A rear frame assembly is typically incorporated into the rear end of a trailer body, such as a tractor trailer body used to transport goods. Current rear case assemblies are typically made of two basic materials. One type of rear case assembly is made of plain carbon steel that is painted. The structural members in this type of rear case assembly are welded together. Welded carbon steel rear case assemblies are undesirable because of their heavy weight, which reduces the usable payload of the tractor trailer. The higher weight also reduces the fuel efficiency of the tractor trailer. Further, it is very difficult and expensive to maintain the appearance of carbon steel, particularly where the appearance and hygienic qualities of the trailer body are important, such as with refrigerated trailers used to carry foodstuffs.

An additional material often used in rear case assemblies is stainless steel. The stainless steel members are welded together in a similar manner to carbon steel members. While avoiding the maintenance issues of painted carbon steel rear case assemblies, the stainless steel members have the same weight, reduction in payload, and fuel efficiency problems associated with carbon steel rear case assemblies. Additionally, stainless steel members are comparatively more expensive than carbon steel members thereby raising the overall cost of the trailer body.

In view of the foregoing, a need exists for a rear case assembly that is lighter in weight yet inexpensive to fabricate and maintain. Additionally, a need exists for a rear case assembly having an attractive appearance, such as with stainless steel rear case assemblies, but overcomes the weight and cost problems associated with stainless steel rear case assemblies. Further, a need exists for a rear case assembly in which the number of parts required to construct the rear case assembly is reduced in comparison to present rear case assembly designs.

### SUMMARY OF THE INVENTION

The present invention is generally directed to an aluminum rear case assembly that is comprised of structural members made of aluminum rather than carbon steel or stainless steel. Aluminum structural members have not previously been adopted in the industry for use in rear case assemblies for motor vehicles. Aluminum has advantages over carbon steel or stainless steel used in the industry because it offers both an attractive appearance and weight reduction, in addition to low maintenance costs. However, the common belief in the art remains that aluminum cannot be substituted for steel even though many aluminum alloys have strength comparable to common carbon steels and stainless steels. The proper selection of aluminum/aluminum alloy structural members in combination with novel and nonobvious connection schemes can yield an all or mostly aluminum structure that provides the same rigidity as steel.

The present disclosure describes several embodiments of a new, useful, and nonobvious aluminum rear case assembly and method of constructing the same. The present invention is also directed to a trailer body, such as a tractor trailer body, having the aluminum rear case assembly incorporated therein.

The aluminum rear case assembly is intended to be incorporated as part of a trailer body and, more particularly, a rear end of a trailer body. The aluminum rear case assembly generally comprises a frame assembly comprising an extruded aluminum top rail, an extruded aluminum bottom rail, and a pair of extruded aluminum side rails connecting the top and bottom rails. The frame assembly generally defines a rectangular shape and has an exposed side and an internal side. The exposed side generally faces outward from the trailer body when the rear case assembly is attached to the trailer body and the internal side faces inward toward the cargo area defined by the trailer body and is configured to be attached to the rear end of the trailer body.

The rear case assembly may further comprise a light guard assembly attached to the bottom rail on the exposed side of the frame assembly. The light guard assembly may comprise a pair of light guard members and a bumper member connecting the light guard members. The light guard members may each define at least one light-receiving socket. The light guard members may be formed of aluminum sheet material and the bumper member may be formed of extruded aluminum. The light guard members may be fixedly joined to the bumper member. Alternatively, the light guard members and the bumper member may be integrally formed as one piece.

The aluminum rear case assembly may further comprise a pair of stiffener members attached to the side rails, respectively, on the exposed side of the frame assembly for increasing the strength of the side rails. The stiffener members may be formed of aluminum sheet material and welded to the side rails.

The aluminum rear case assembly may further comprise a pair of reinforcement plates attached, respectively, to the side rails and bottom rail on the internal side of the frame assembly. The reinforcement plates may be formed of aluminum sheet material and welded to the side rails and bottom rail.

The aluminum rear case assembly may further comprise at least a pair of extruded aluminum hinges attached to the side rails, respectively. The aluminum hinges may be attached to the side rails by mechanical fasteners or by welds.

In one embodiment of the aluminum rear case assembly, the top rails and side rails and the bottom rail and side rails are connected together by mechanical fasteners or welds. In another embodiment of the aluminum rear case assembly, cast aluminum corner joints are used to connect the bottom rail and side rails. Additional cast aluminum corner joints may be used to connect the top rail and side rails. Further, the top rail and side rails may be connected together by mechanical fasteners or welds and the bottom rail and side rails may be connected together by a pair of the cast aluminum corner joints.

The present invention is also generally directed to a method of making a rear case assembly for a trailer body. The method may comprise the steps of extruding a top rail comprised of aluminum; extruding a bottom rail comprised of aluminum; extruding a pair of side rails comprised of aluminum; and joining the top rail to the side rails and the bottom rail to the side rails to form a rectangular shaped frame assembly. The top rail may be joined to the side rails by mechanical fasteners or welds. The bottom rail may be joined to the side rails by mechanical fasteners or welds. The method may further comprise the steps of casting a pair of aluminum corner joints and joining the top rail to the side rails with the corner joints, respectively. Additionally, the method may comprise the steps of casting a pair of aluminum corner joints and joining the bottom rail to the side rails with the corner joints, respectively.

Further details and advantages will become apparent from the following detailed description read in conjunction with the drawings, wherein like parts are indicated with like reference numerals.

### BRIEF DESCRIPTION OF THE DRAWINGS

FIG. 1 is a perspective view of a rear end of a trailer body incorporating a rear case assembly in accordance with the present invention;

FIG. 2 is a perspective view of the rear case assembly in accordance with a first embodiment of the present invention;

FIG. 3 is a perspective view of a top corner joint of the rear case assembly of FIG. 2;

FIG. 4 is a perspective view of a bottom corner joint of the rear case assembly of FIG. 2;

FIG. 5 is a perspective view of the rear case assembly in accordance with a second embodiment of the present invention;

FIG. 6 is a perspective view of a bottom corner joint of the rear case assembly of FIG. 5;

FIG. 7 is an exploded perspective view of the bottom corner joint of FIG. 6;

FIG. 8 is a perspective view of the rear case assembly in accordance with a third embodiment of the present invention;

FIG. 9 is a perspective view of a top corner joint of the rear case assembly of FIG. 8;

FIG. 10 is a perspective view showing internal details of the top corner joint of FIG. 9;

FIG. 11 is a perspective view of a bottom corner joint of the rear case assembly of FIG. 7;

FIG. 12 is an alternative embodiment of the top corner joint of FIG. 9;

FIG. 13 is a perspective view of the trailer body of FIG. 1 incorporating a rear case assembly made in accordance with another embodiment of the present invention and configured to support a rolling door;

FIG. 14 is a second perspective view of the rear case assembly of FIG. 13;

FIG. 15 is a perspective view of a bottom corner joint of the rear case assembly shown in FIGS. 13 and 14; and

FIG. 16 is a perspective view of an aluminum hinge member attached to the rear case assembly of the present invention.

### DESCRIPTION OF THE PREFERRED EMBODIMENTS

For purposes of the description hereinafter, the terms “upper”, “lower”, “right”, “left”, “vertical”, “horizontal”, “top”, “bottom”, and derivatives thereof, shall relate to the invention, as it is oriented in the drawing figures. However, it is to be understood that the invention may assume various alternatives and step sequences, except where expressly specified to the contrary. It is also to be understood that the specific elements and processes illustrated in the drawings, and described in the following specification, are simply exemplary embodiments of the invention. Hence, specific dimensions and other physical characteristics related to the embodiments disclosed herein are not to be considered limiting.

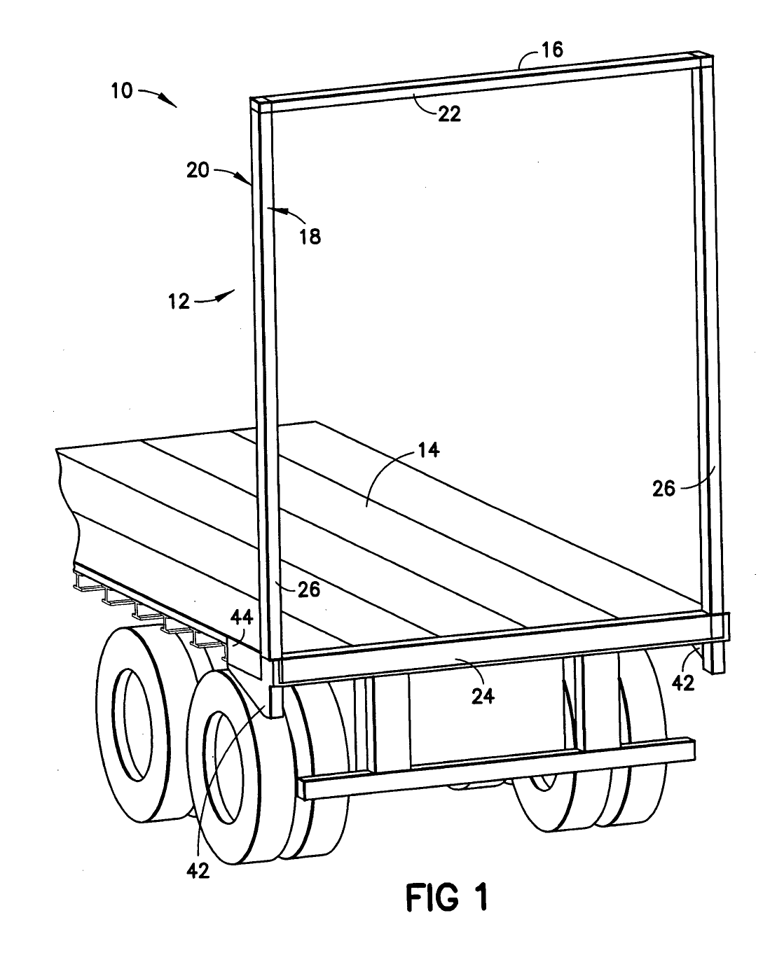

FIG. 1 generally shows a trailer body 10, such as a tractor trailer body, incorporating a rear case assembly 12 in accordance with the present invention. The trailer body 10 is a conventional trailer body comprising a storage or cargo area 14. The rear case assembly 12 is a generally rectangular structure and is intended to be attached to the rear end of the trailer body 10 as depicted, and as is well known in the art.

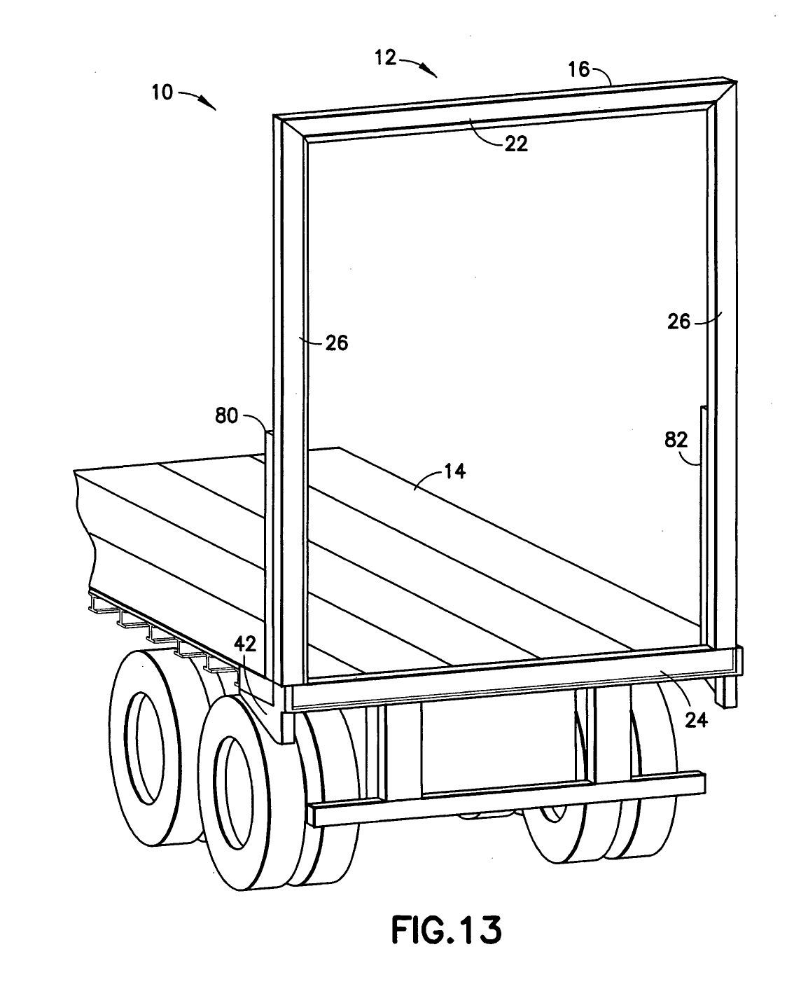

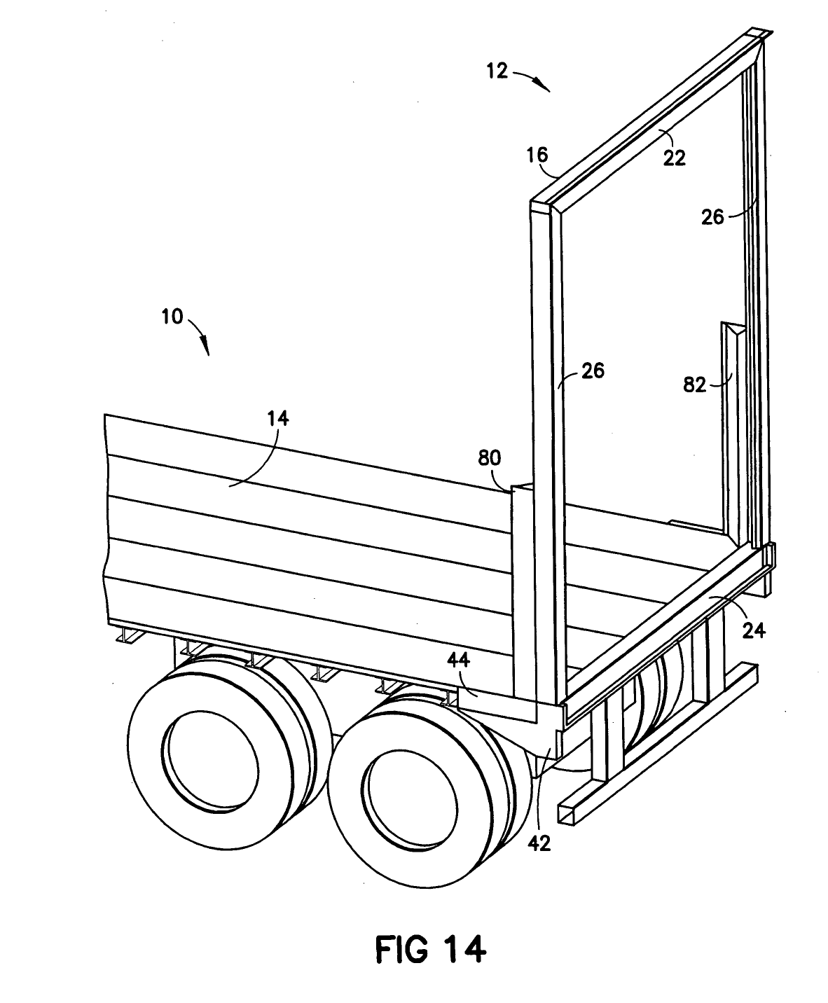

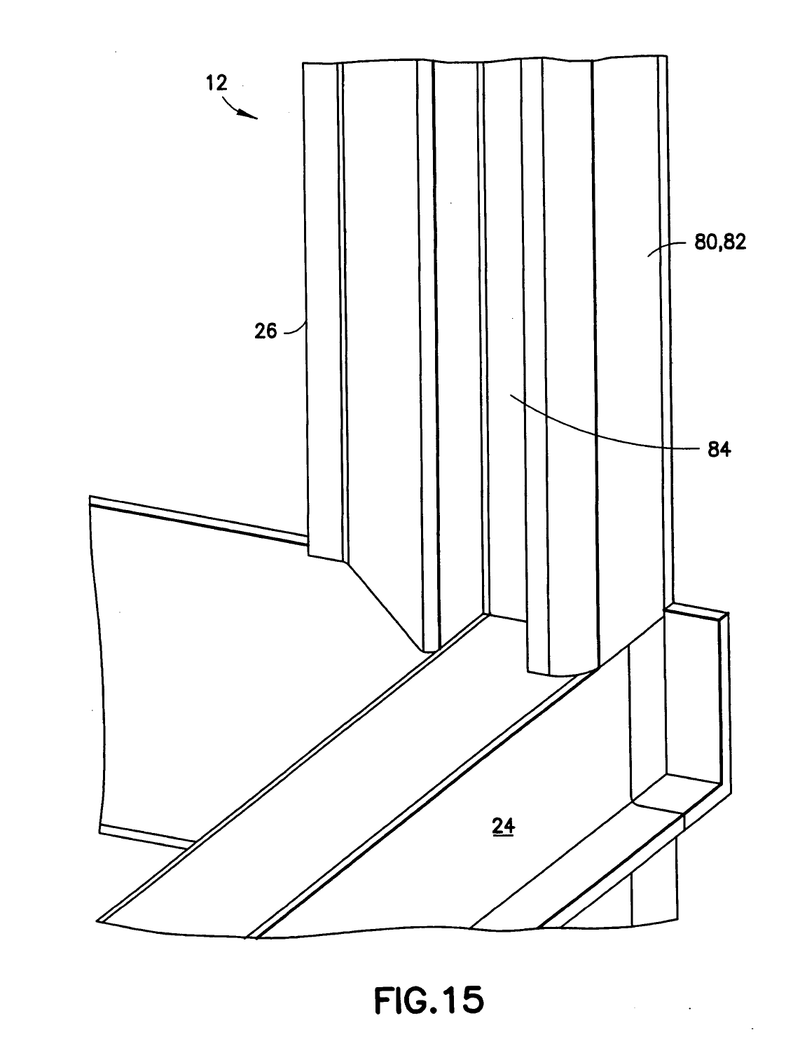

The rear case assembly 12 is generally configured to support a door (not shown) that encloses the cargo area 14 of the trailer body 10. The door may be a single door or a pair of doors affixed hingedly to the rear case assembly 12. Additionally, the rear case assembly 12 may be configured to support a rolling door, as generally illustrated in FIGS. 13-15 discussed hereinafter.

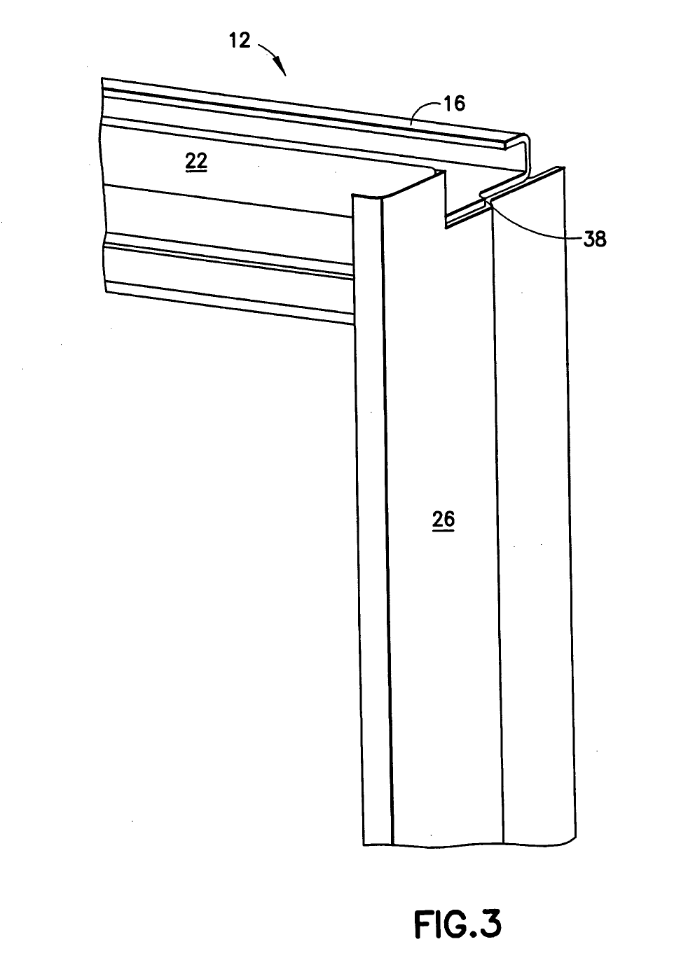

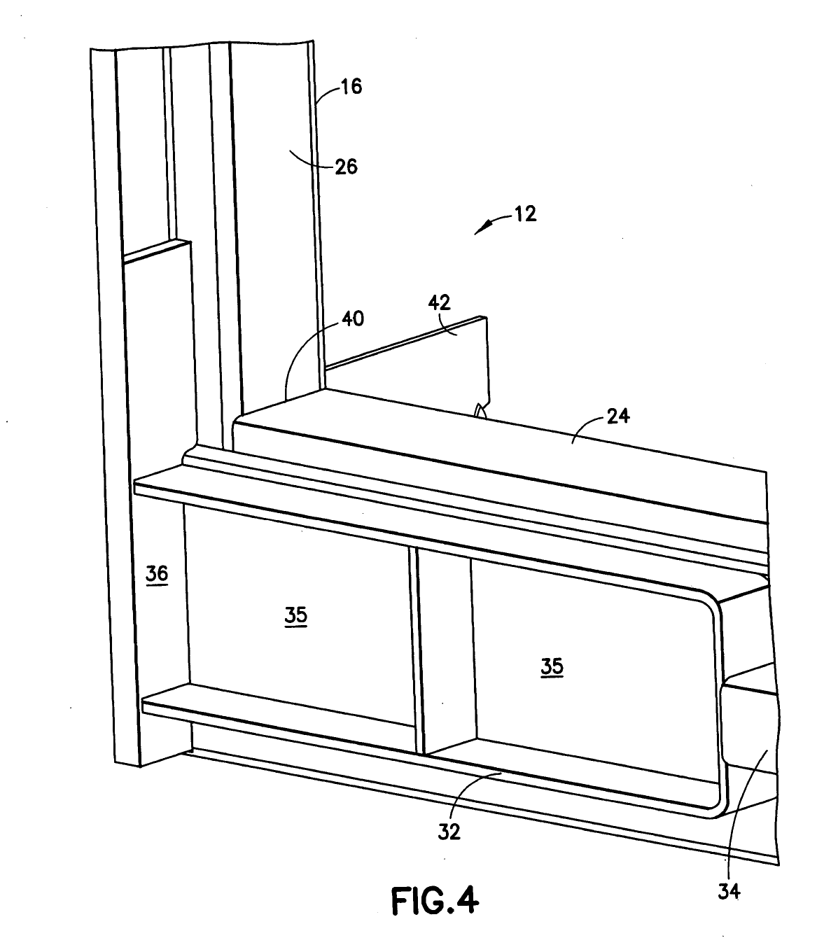

Referring to FIGS. 1-4, a first embodiment of the rear case assembly 12 is shown. The rear case assembly 12 is generally comprised of aluminum structural members making the rear case assembly 12 significantly lighter than the steel rear case assemblies known in the art and discussed previously. The rear case assembly 12 is comprised of a frame assembly 16 having an exposed side 18 facing outwardly from the trailer body 10 and cargo area 14 and an internal side 20 that generally faces the cargo area 14 of the trailer body 10. The internal side 20 is attached to the rear end of the trailer body 10 by methods of attachment customary in the art, such as riveting or mechanical fasteners.

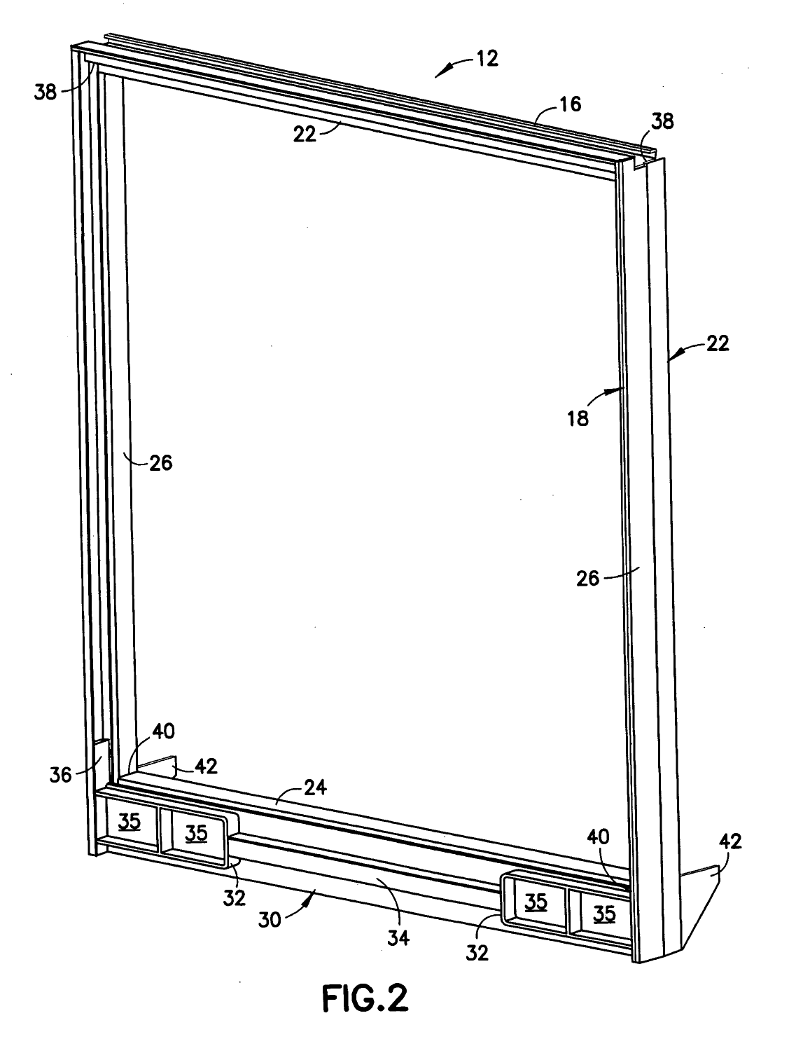

The frame assembly 16 is comprised of an extruded aluminum top rail 22, an extruded aluminum bottom rail 24, and a pair of extruded aluminum side rails 26 connecting the top and bottom rails 22, 24. The frame assembly 16 has a generally rectangular shape sized to conform to the rear end of the trailer body 10. In the first embodiment of the rear case assembly 12, the top rail 22 is joined to the side rails 26 by mechanical fasteners or by welds. Similarly, the bottom rail 24 is joined to the side rails 26 by mechanical fasteners or welds. In FIGS. 2-4, the top rail 22 and bottom rail 24 are shown welded to the side rails 26.

The rear case assembly 12 further comprises a light guard assembly 30 attached to the bottom rail 24 on the exposed side 18 of the frame assembly 16. The light guard assembly 30 is comprised of a pair of light guard members 32 and a bumper member 34 connecting the light guard members 32. The light guard members 32 each define at least one light-receiving socket 35 configured to receive a rear light (not shown) of the trailer body 10. The light guard members 32 may be formed of aluminum sheet material or as an extruded aluminum piece. The light guard members 32 are preferably fixedly joined to the bumper member 34 by mechanical fasteners or welds. Alternately, the light guard members 32 and the bumper member 34 may be integrally formed as a one-piece unit, preferably an extruded aluminum one-piece unit.

A pair of stiffener members 36 is attached to the side rails 26, respectively. The stiffener members 36 are attached to the side rails 26 on the exposed side 18 of the frame assembly 16. The stiffener members 36 may be formed of aluminum sheet material or as extruded aluminum pieces. The stiffener members 36 may be joined to the side rails 26 by mechanical fasteners or welds. The stiffener members 36 provide additional support for the side rails 26 at the joint connections between the side rails 26 and bottom rail 24. Hereinafter, the joint connections between the side rails 26 and bottom rail 24 will be referred to as “bottom corner joints” and the joint connections between the side rails 26 and top rail 22 will be referred to as “top corner joints”. The top corner joints are hereinafter assigned reference numeral “38” and the bottom corner joints are assigned reference numeral “40”. The top corner joints 38 and bottom corner joints 40 in the first embodiment of the rear case assembly 12 shown in FIGS. 1-4 are comprised of welds.

The rear case assembly 12 further comprises a pair of reinforcement plates 42 attached, respectively, to the side rails 26 and bottom rail 24 on the internal side 20 of the frame assembly 16. As shown in FIG. 1, the reinforcement plates 42 may be attached to a frame 44 of the trailer body 10. The reinforcement plates 42 may be formed of aluminum sheet material or formed as extruded aluminum pieces. The reinforcement plates 42 may be attached to the side rails 26 and bottom rail 24 by mechanical fasteners or welds. Similarly, the reinforcement plates 42 may be joined to the frame 44 of the trailer body 10 by mechanical fasteners or welds.

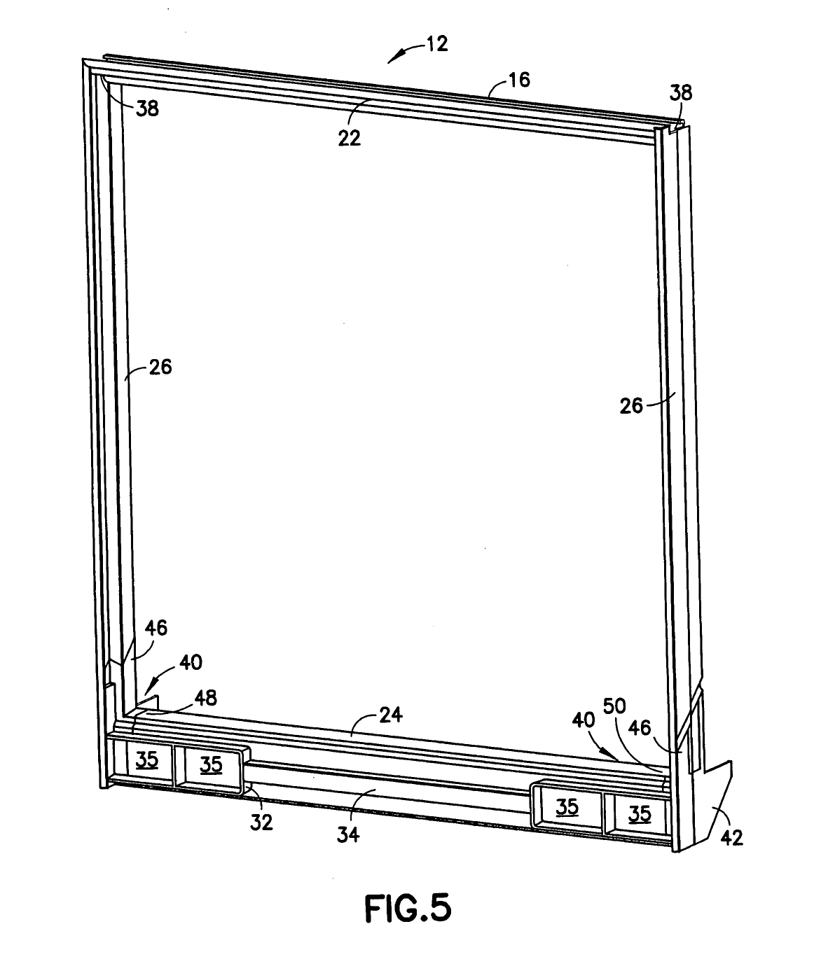

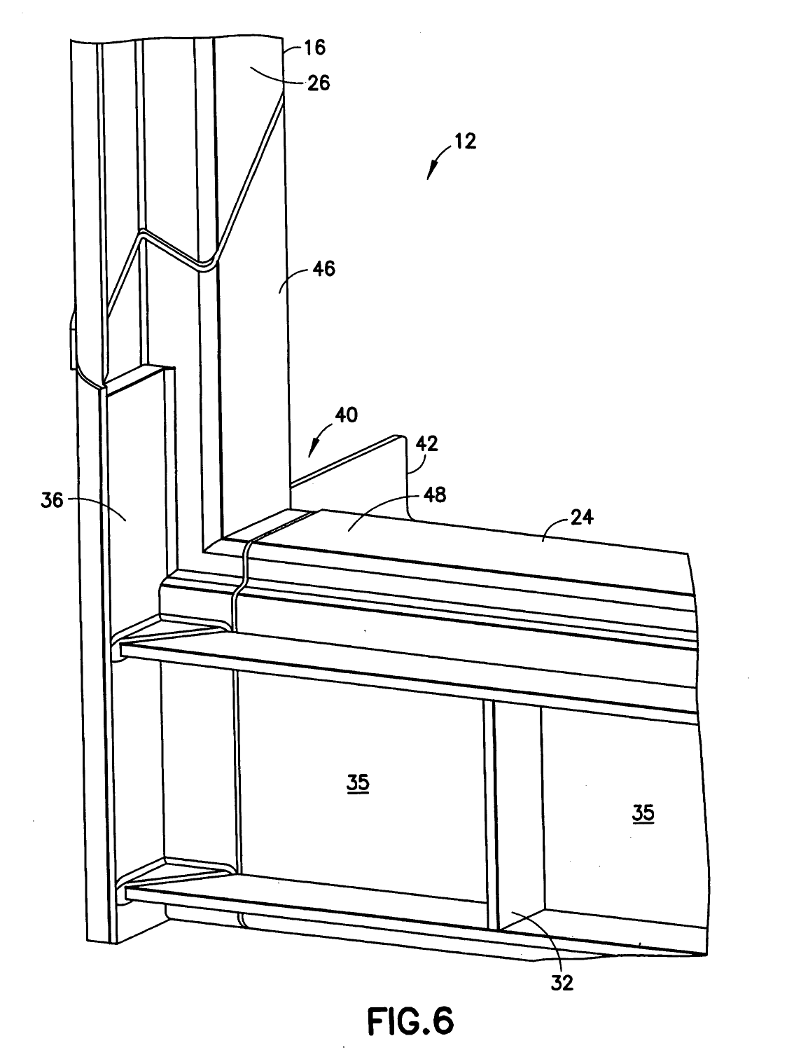

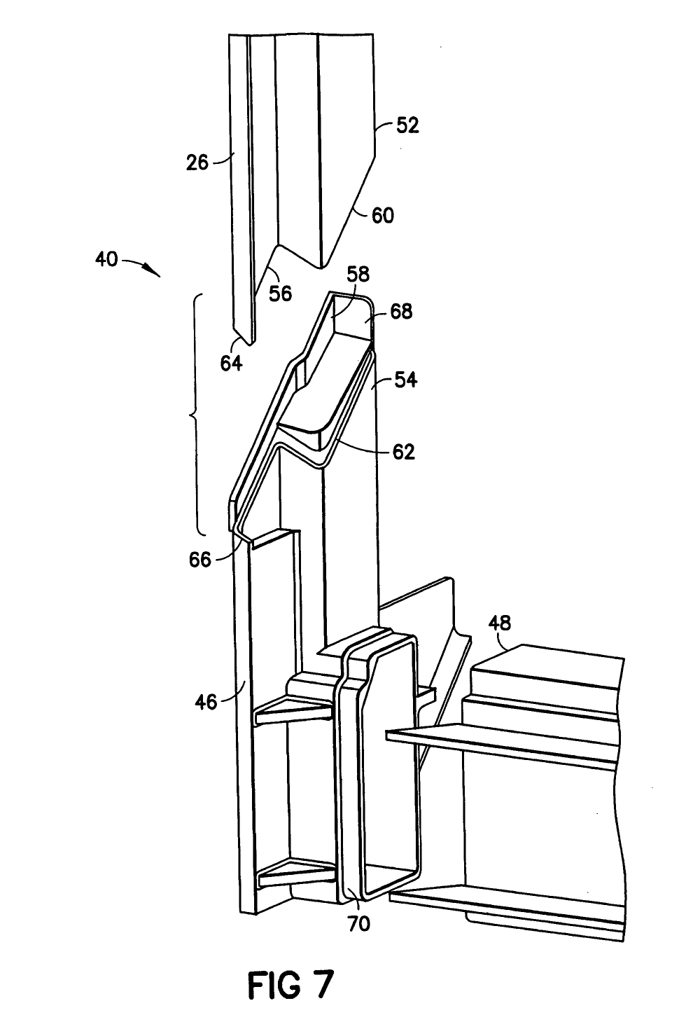

FIGS. 5-7 show a second embodiment of the rear case assembly 12. In the embodiment shown in FIGS. 5-7, the frame assembly 16 comprises the elements discussed previously. In particular, the frame assembly 16 comprises the extruded top, bottom, and side rails 22, 24, 26. The top corner joints 38 connecting the top rail 22 and side rails 26 are identical to the top corner joints 38 discussed previously in connection with FIGS. 1-4. The embodiment of the rear case assembly 12 of FIGS. 5-7 differs from the first embodiment in that the bottom joints 40 are comprised of cast corner joints 46. In particular, the side rails 26 are connected to opposite ends 48, 50 of the bottom rail 24 by a pair of cast aluminum corner joints 46. The other features of the rear case assembly 12 of FIGS. 5-7 are identical to the features of the rear case assembly 12 of FIGS. 1-4.

The corner joints 46 connect the side rails 26 to the bottom rail 24 with a staggered lap configuration. In the respective staggered lap connections, a lower end 52 of the side rail 26 cooperates with an upper end 54 of the corner joint 46. In particular, an outer edge 56 of the lower end 52 is received inside of an outer edge 58 of the upper end 54 of the corner joint 46. An inner edge 60 of the lower end 52 of the side rail 26 is configured to cooperate with an inner edge 62 of the upper end 54 of the corner joint 46. A weld may be applied to the outer edge 58 of the upper end 54 of the corner joint 46 to join the corner joint 46 to the side rail 26. Similarly, a weld may be applied to the inner edge 62 of the corner joint 46 and the inner edge 60 of the side rail 26 to fixedly join the inner edges 60, 62. The weld connection between the side rail 26 and corner joint 46 is preferably continuous around the circumference of the side rail 26 and corner joint 46. Accordingly, a front lower edge 64 of the side rail 26 is joined to a front upper edge 66 of the corner joint 46 and a rear lower edge (not shown) of the side rail 26 is joined to a rear upper edge 68 of the corner joint 46. The connection between the corner joint 46 and the lower rail 24 may be a conventional sleeve joint 70, as shown.

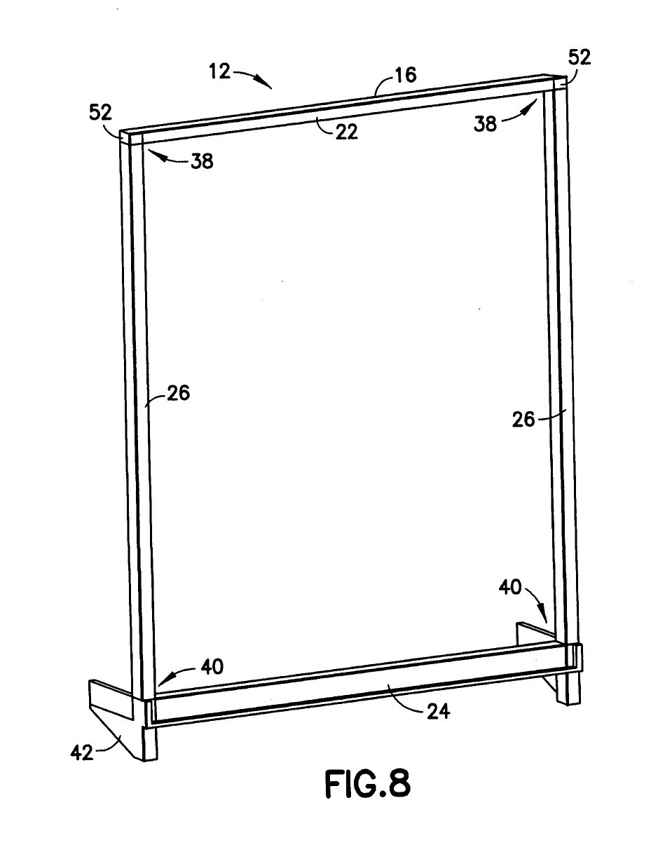

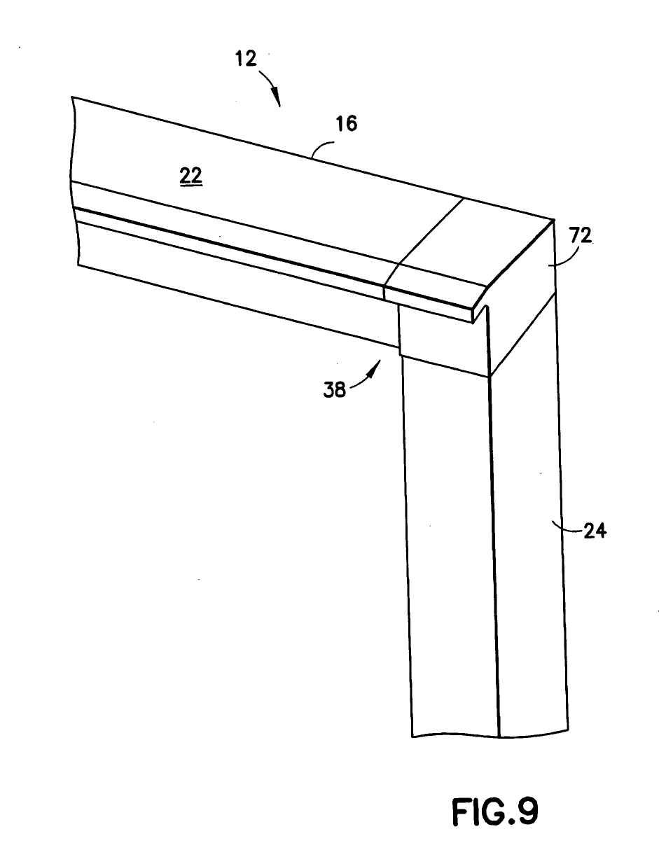

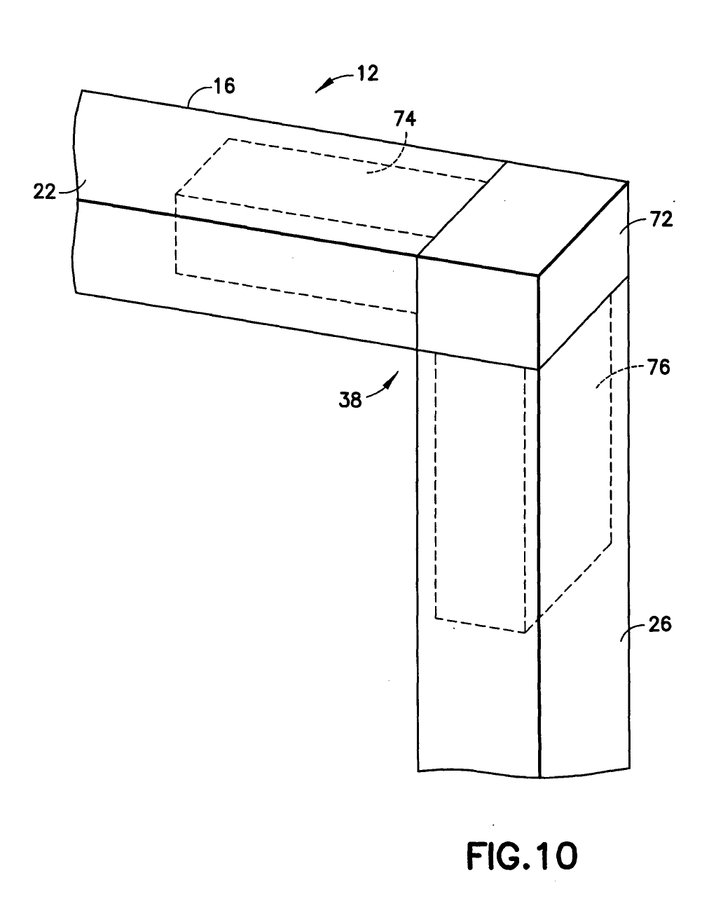

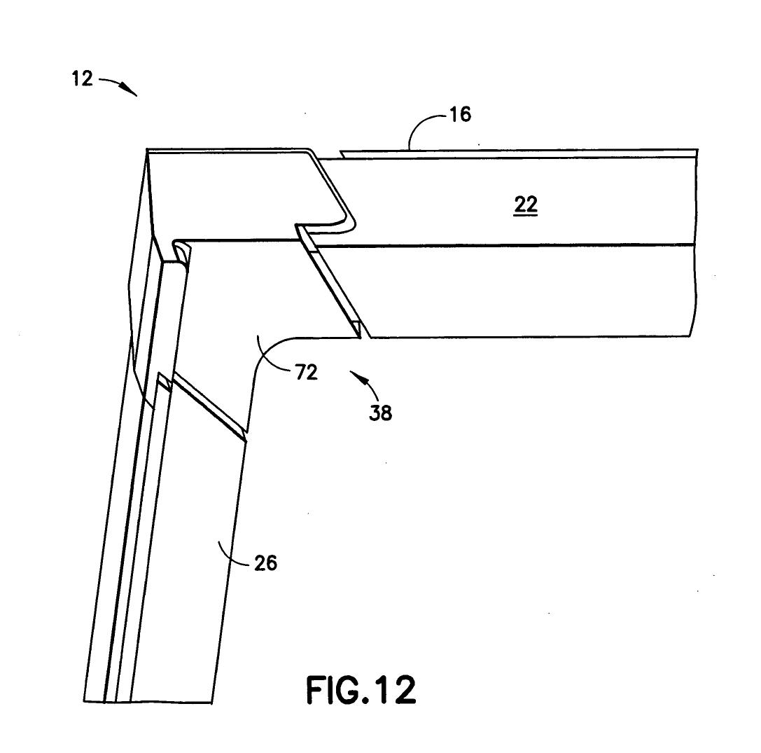

Referring to FIGS. 8-12, a third embodiment of the rear case assembly 12 is shown. The frame assembly 16 of the third embodiment is substantially similar to the embodiments discussed previously. However, the top and bottom corner joints 38, 40 connecting the top rail 22 to the side rails 26 and the bottom rail 24 to the side rails 26, respectively, are slightly modified. The top, bottom, and side rails 22, 24, 26 are each extruded aluminum structural members as discussed previously. The top corner joints 38 connecting the top rail 22 to the side rails 26 are now comprised of cast aluminum elbow joints 72 as shown, for example, in FIGS. 9 and 10. The cast aluminum elbow joints 72 each comprise a pair of projections 74, 76 that are received within the tubular structure of the extruded aluminum top rail and side rails 22, 26. One of the top corner joints 38 is shown in detail in FIG. 10. The top corner joint 38 is comprised of the elbow 72 with its two projections 74, 76 extending into the hollow ends of the top rail 22 and side rail 26, as shown. A similar arrangement is provided for the cast aluminum elbow joint 72 connecting the opposite side rail 26 to the top rail 22. FIG. 12 shows an alternative embodiment of the cast aluminum elbow joint 72 used as the top corner joint 38. The elbow joint 72 in FIG. 12 is now formed as a substantially exposed corner member or piece. The elbow joint 72 of FIG. 12 is configured to partially sleeve-over the top rail 22 and side rail 26. The elbow joint 72 of FIG. 12 also has the projections 74, 76 used to connect the elbow joint 72 to the top rail 22 and side rail 26.

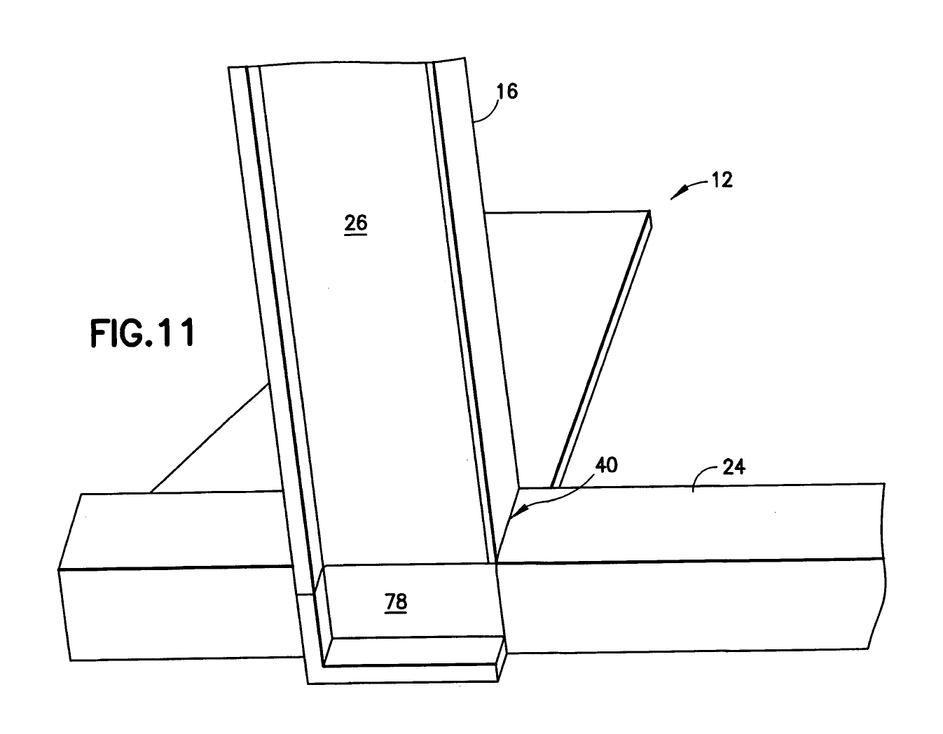

The cast aluminum corner joint 46 shown in FIGS. 5-7 may be replaced by a cast aluminum elbow joint 78 having a similar configuration to the elbow joint 72 discussed hereinabove. As shown, for example, in FIG. 11, the bottom corner joint 40 is now comprised of the cast aluminum elbow joint 78. The elbow joint 78 has two connecting projections (not shown) in a similar manner to the elbow joint 72 discussed hereinabove. The other aspects of the frame assembly 16 of FIGS. 8-12 are identical to the frame assemblies 16 discussed previously in connection with FIGS. 1-7.

FIGS. 13-15 show a fourth embodiment of the rear case assembly 12, which is now configured to support a rolling door (not shown). The “rolling door” embodiment of the rear case assembly 12 further comprises a pair of channel members 80, 82, for example, extruded aluminum channel members, attached fixedly to the side rails 26, respectively. The channel members 80, 82 may be attached to the side rails 26 by welds, rivets, or mechanical fasteners. The channel members 80, 82 each define a recess 84 that is used to house the rolling elements of the rolling door, as will be appreciated by those skilled in the art. The frame assembly 16 used in the “rolling door” embodiment of the rear case assembly 12 may be any of the three embodiments of the rear case assembly 12 discussed hereinabove in connection with FIGS. 1-12. All other aspects of the frame assembly 16 of FIGS. 13-15 are identical to the frame assembly 16 of FIGS. 1-12.

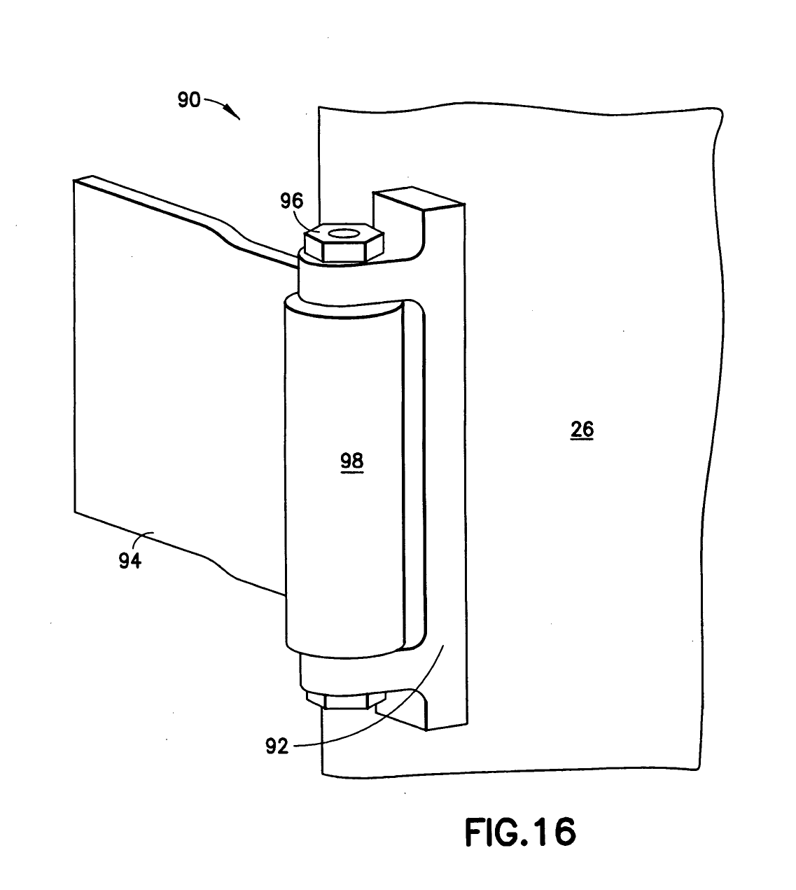

Referring to FIG. 16, the rear case assembly 12 of the present invention may further comprise extruded aluminum hinge members 90 affixed to the side rails 26. The extruded aluminum hinge members 90 are comprised of an extruded aluminum base plate 92 and a hinge plate 94 connected to the base plate 92 by a pin 96. The pin 96 may be made of a hard material such as steel, or of aluminum. The hinge plate 94 has a cylindrical portion 98 for receiving the pin 96 to connect the hinge plate 94 to the base plate 92. Preferably, the hinge plate 94 is an extruded aluminum hinge plate. The hinge members 90 may be used to support a door used to enclose the cargo area 14 defined by the trailer body 10, as is conventional in the art.

The present invention is further directed to a method of making the rear case assembly 12 in accordance with the present invention. Initially, the method requires extruding the top rail 22, bottom rail 24, and side rails 26 of aluminum. In this disclosure, the term “aluminum” is intended to mean both aluminum and aluminum alloys. Suitable aluminum/aluminum alloys for forming the various aluminum parts described hereinabove include 6061-T6 and 6063-T6 and equivalent metals and materials. Once the top rail 22, bottom rail 24, and side rails 26 are extruded, the top rail 22 and bottom rail 24 are joined to the side rails 26 to form the rectangular shaped frame assembly 16. The top rail 22 may be joined to the side rails 26 by mechanical fasteners or welds as indicated previously in connection with the first embodiment of the rear case assembly 12 shown in FIGS. 1-4. A similar connection may be provided for the bottom rail 24 and side rails 26.

The second embodiment of the rear case assembly 12 requires the use of cast aluminum corner joints 46 for the bottom corner joints 40. Therefore, the method of the present invention may further require the steps of casting a pair of aluminum corner joints 46 and joining the bottom rail 24 to the side rails 26 with the cast aluminum corner joints 46. The side rails 26 may be joined to the bottom rail 24 by the pair of cast aluminum corner joints 46 as discussed previously in connection with FIGS. 5-7.

The third embodiment of the rear case assembly 12 requires four cast aluminum elbow joints, including two top elbow joints 72 and two bottom elbow joints 78 for connecting the top rail 22 to the side rails 26 and the bottom rail 24 to the side rails 26, respectively. The method of making the rear case assembly 12 of the present invention may further comprise the steps of casting the four aluminum elbows 72, 78 and forming the frame assembly 16 with the top, bottom, and side rails 22, 24, 26 connected by the respective top elbow joints 72 and bottom elbow joints 78. If the rear case assembly 12 is intended for use with a rolling door, the method of the present invention further requires the steps of extruding a pair of the aluminum channels 80, 82 and affixing the channels 80, 82 to the side rails 26, respectively. The extruded aluminum channels 80, 82 may be affixed to the side rails 26 by the attachment methods indicated previously.

While the rear case assembly of the present invention was described hereinabove in connection with several embodiments, modifications and alterations may be made to the rear case assembly without departing from the spirit and scope of the present invention. The present invention is defined by the appended claims and all changes to the invention that fall within the meaning and range of equivalency of the appended claims are to be embraced within their scope.

The invention claimed is:

1. An aluminum rear case assembly for a trailer body, comprising a frame assembly comprising an extruded aluminum top rail, an extruded aluminum bottom rail, and a pair of extruded aluminum side rails connecting the top and bottom rails, the frame assembly defining a rectangular shape and having an exposed side facing outward from the trailer body when the rear case assembly is attached to the trailer body and an internal side configured to be attached to the trailer body.

2. The aluminum rear case assembly of claim 1 further comprising a light guard assembly attached to the bottom rail on the exposed side of the frame assembly, the light guard assembly comprising a pair of light guard members and a bumper member connecting the light guard members, the light guard members each defining at least one light-receiving socket.

3. The aluminum rear case assembly of claim 2 wherein the light guard members are formed of aluminum sheet material and the bumper member is formed of extruded aluminum, and wherein the light guard members are fixedly joined to the bumper member.

4. The aluminum rear case assembly of claim 2 wherein the light guard members and bumper member are integrally formed as one piece.

5. The aluminum rear case assembly of claim 1 further comprising a pair of stiffener members attached to the side rails, respectively, on the exposed side of the frame assembly for increasing the strength of the side rails.

6. The aluminum rear case assembly of claim 5 wherein the stiffener members are formed of aluminum sheet material and welded to the side rails.

7. The aluminum rear case assembly of claim 1 further comprising a pair of reinforcement plates attached, respectively, to the side rails and bottom rail on the internal side of the frame assembly.

8. The aluminum rear case assembly of claim 7 wherein the reinforcement plates are formed of aluminum sheet material and welded to the side rails and bottom rail.

9. The aluminum rear case assembly of claim 1 further comprising at least a pair of extruded aluminum hinges attached to the side rails, respectively.

10. The aluminum rear case assembly of claim 9 wherein the aluminum hinges are attached to the side rails by mechanical fasteners or by welds.

11. The aluminum rear case assembly of claim 1 further comprising cast aluminum corner joints connecting the bottom rail and side rails.

12. The aluminum rear case assembly of claim 11 further comprising cast aluminum corner joints connecting the top rail and side rails.

13. The aluminum rear case assembly of claim 1 further comprising cast aluminum corner joints connecting the top rail and side rails.

14. The aluminum rear case assembly of claim 1 wherein the top rail and side rails and the bottom rail and side rails are connected together by mechanical fasteners or welds.

15. The aluminum rear case assembly of claim 1 wherein the top rail and side rails are connected together by mechanical fasteners or welds and the bottom rail and side rails are connected together by cast aluminum corner joints.

16. The aluminum rear case assembly of claim 1 further comprising at least one extruded aluminum hinge member affixed to at least one of the side rails, the hinge member comprising an extruded aluminum base plate and an extruded aluminum hinge plate connected to the base plate by a pin, the hinge plate having a cylindrical portion for receiving the pin to connect the hinge plate to the base plate.

17. A method of making a rear case assembly for a trailer body, comprising the steps of:
extruding a top rail comprised of aluminum;
extruding a bottom rail comprised of aluminum;
extruding a pair of side rails comprised of aluminum; and
joining the top rail to the side rails and the bottom rail to the side rails to form a rectangular shaped frame assembly.

18. The method of claim 17 wherein the top rail is joined to the side rails by mechanical fasteners or welds.

19. The method of claim 18 wherein the bottom rail is joined to the side rails by mechanical fasteners or welds.

20. The method of claim 17 wherein the bottom rail is joined to the side rails by mechanical fasteners or welds.

21. The method of claim 17 further comprising the steps of casting a pair of aluminum corner joints and joining the top rail to the side rails with the corner joints, respectively.

22. The method of claim 21 further comprising the steps of casting a pair of aluminum corner joints and joining the bottom rail to the side rails with the corner joints.

23. The method of claim 17 further comprising the steps of casting a pair of aluminum corner joints and joining the bottom rail to the side rails with the corner joints.

24. The method of claim 23 wherein the top rail is joined to the side rails by mechanical fasteners or welds.

25. A trailer body, comprising a box-shaped cargo area having a rear end and an aluminum rear case assembly attached to the rear end, the aluminum rear case assembly comprising a frame assembly comprising an extruded aluminum top rail, an extruded aluminum bottom rail, and a pair of extruded aluminum side rails connecting the top and bottom rails, the frame assembly defining a rectangular shape and having an exposed side facing outward from the trailer body and an internal side attached to the rear end of the box-shaped cargo area.
